(19) United States
(12) Patent Application Publication
(10) Pub. No.: US 2010/0210770 A1
(43) Pub. Date: Aug. 19, 2010

(54) ELASTOMERIC COMPOSITE

(76) Inventors: Jacques Nadeau, Waterloo (CA); James Frederick Fisher, Brampton (CA)

Correspondence Address: VALENTINE A COTTRILL;SUSAN TANDAN, 50 QUEEN STREET NORTH, STE. 1020, P.O. BOX 2248, KITCHENER, ON, N2H6M2, CA

(21) Appl. No.: 12/704,945

(22) Filed: Feb. 12, 2010

Related U.S. Application Data
(60) Provisional application No. 61/202,290, filed on Feb. 13, 2009.

(51) Int. Cl. C08K 5/00; C08K 5/09; C08K 5/053

(52) U.S. Cl. 524/300; 524/81; 524/386

(57) ABSTRACT

An elastomeric composite comprising a synthetic rubber which incorporates a biofiller is provided.

### FIELD OF THE INVENTION

The present invention relates to the field of elastomers, and in particular, to elastomer composites comprising at least one biofiller.

### BACKGROUND OF THE INVENTION

Synthetic rubbers are widely used and provide advantages over natural rubber. The monomeric components of a synthetic rubber can be customized to provide a product with a wide range of physical, mechanical and chemical properties. In addition, the properties of a resulting synthetic product can be optimized based on the purity of the components used in its manufacture.

Existing Rubber composites may incorporate non-elastomeric components for the purpose of providing a product with unique characteristics that potentially render it advantageous over existing rubbers. For example, WO 89/002908 describes a rubber composite comprising polyester fibers as the reinforcing material, while composites comprising clay, iron/nickel nanoparticles and plastics have also been disclosed.

The manufacture of rubber composites comprising filler components which are readily available at low-cost has also been contemplated to provide a more economical composite product having adequate characteristics for a given application. Research in this regard is ongoing.

It would be desirable to develop a rubber composite useful to replace existing synthetic rubbers that provides an appropriate, cost-effective alternative.

### SUMMARY OF THE INVENTION

A novel elastomeric composite has now been developed in which a synthetic rubber compound includes a biofiller.

In one aspect of the present invention, thus, an elastomeric composite is provided comprising a synthetic rubber compound which incorporates a biofiller.

In another aspect of the invention, a method of making an elastomeric composite is provided comprising mixing a base polymer or polymers with at least one filler and a curing package under conditions suitable to result in vulcanization, wherein said filler comprises a biofiller.

These and other aspects of the invention will become apparent from the description that follows.

### DETAILED DESCRIPTION OF THE INVENTION

An elastomeric composite comprising a synthetic rubber compound combined with at least one biological filler is provided.

The term “synthetic rubber compound” is not particularly restricted and is meant to include any artificially made polymer material which acts as an elastomer including, but not limited to, polybutadiene; chloro isobutylene isoprene; polychloroprene; chlorosulphonated polyethylene; epichlorohydrin; ethylene propylene; ethylene propylene diene; ethylene vinyl acetate; fluoronated hydrocarbon; hydrogenated nitrile butadiene; polyisoprene; isoprene butylene butyl; butadiene acrylonitrile; polyurethane; styrene butadiene; and poly-siloxane. Preferred synthetic polymers include ethylene propylene diene (EPDM), styrene butadiene (SBR), isoprene butylene butyl (IIR), butadiene acrylonitrile (NBR), and polychloroprene (CR).

The term “biofiller” is meant to encompass materials derived from agricultural products and/or by-products, such as products and/or by-products derived from plants and animals. A biofiller in accordance with the invention may include one or more of starch, protein, carbohydrate or fibrous-containing components. Examples of suitable components include the flour, meal, hull or oil of any of cereals such as wheat and barley, oilseed such as canola and legumes such as soya; glycerol; distiller's dried grain and solutes (DDGS); lignon; straw e.g. wheat; forestry waste and the like.

The elastomeric composite is made by combining the components used to manufacture the synthetic polymer, for example, a selected base polymer or polymers (such as styrene, butadiene, isoprene and mixtures thereof), at least one biofiller, and suitable components selected from the following: oils (e.g. plasticizer oils to reduce the melt viscosity of the rubber during its processing, for example, mineral oils containing known quantities of paraffinic, naphthenic and aromatic molecules), active fillers (e.g. zinc oxide and stearic acid), inactive fillers (such as carbon black, whiting, silica, carbonates, kaolin, clay and talc) and a curing package including a cure agent such as sulfur or peroxide together with accelerators (e.g., sulfenamides, thiurams, or thiazoles) and retarding agents (e.g. antimony trioxide, zinc borate, chlorinated paraffin wax and decabromodiphenyl ether).

The elastomeric composite may vary with respect to the components it comprises depending on the desired characteristics of the composite, as one of skill in the art will appreciate. Thus, the recipe for making the composite is a compromise between the desired hardness and other performance characteristics of the product, as well as the mixing and processing characteristics of the components to result in the composite product. For example, to vary the hardness of the resulting composite, the type and amount of filler may be varied to result in a composite with either increased or decreased hardness.

Generally, the present elastomeric composite will comprise an amount of biofiller of up to about 50% by weight of the composite, preferably about 10%-40% by weight of the composite, and most preferably about 15-35% by weight of the composite, for example about 25% by weight of the composite.

Once determined, the components of the composite are mixed under conditions suitable to produce homogenized uncured rubber compound. As one of skill in the art will appreciate, the conditions used may vary depending on the components of the composite. Generally, the components are mixed at a temperature in the range of about 100-180° C., for example, 110-130° C., such as 120° C. In some cases, with components that are more readily mixed at higher temperatures, for example when a propylene base polymer is used, it may be appropriate to prepare the composite in a 2-step process including a first high temperature mixing step (e.g. at a temperature in the range of about 150-180° C.) followed by a lower temperature mixing step (e.g. at a temperature in the range of about 100-150° C.). Alternatively, a single-step process may be utilized in which the components are mixed at a single temperature appropriate for the selected components. Such single step processes are generally employed with most EPDM base polymers.

Following mixture of the components, the homogenized rubber compound is then cured at appropriate temperature for a suitable amount of time to achieve the desired product. As one of skill in the art will appreciate, curing temperature will vary with the components of the composite and is generally in the range of about 125-200° C. In accordance with an embodiment of the present invention, the elastomeric composite is cured at a temperature of up to about 177° C. for a period of about 3-12 minutes.

The physical properties of an elastomeric composite in accordance with the present invention include a hardness in the range of about 40-100 Shore A, for example, 75-85 Shore A; tensile strength in the range of about 500-3000 psi; and elongation of from about 100-700%.

The present elastomeric composite comprising biofiller is advantageous over composites that include non-biofillers, for example, composites that include recycled rubber content as filler. At the outset, biofiller is a sustainable component and an environmentally friendly component in comparison to recycled rubber product fillers and other non-biofillers. In addition, biofillers are easier to work with due to their desirable physical characteristics, e.g. they comprise finer particles than recycled rubber products which require much time, effort and cost to grind. The present composites, while able to provide similar physical characteristics to composites comprising non-biofillers, are lighter in weight than those including non-biofillers.

Embodiments of the invention are described by the following specific example which is not to be construed as limiting.

### Example 1

### EPDM Rubber Formulation Containing Bio-Based Fillers

EPDM rubber formulations were prepared using a conventional internal mixer (Brabender) for elastomeric compositions. The formulations were prepared in order to fulfill the requirements for an Original Equipment Radiator seal having the following specifications: hardness—80 Shore A, tensile strength—3.8 MPa/min, elongation at break—174%, modulus at 100% elongation—3.0, tear strength kN/m, min—26 (WSS-M2D476-A5).

Buna EPDM was used as the base polymer. In this case, compounds were derived to generally meet an expected Shore A hardness of about 80+/−5 and include up to about 25% biofiller.

TABLE 1

| WSS-M2D476-A5 | Sample A | Sample B | Sample C | Sample D |
|---|---|---|---|---|
| 190609 | | | | |
| Buna 6470 | 60 | 60 | 60 | 60 |
| Buna 3440 | 40 | | | |
| Buna 3850 | | 40 | 40 | 40 |
| N330 | 100 | 120 | 130 | 130 |
| Soy Flour | 50 | 90 | 60 | 40 |
| ZNO | 5 | 5 | 5 | 5 |
| Stearic Acid | 1.5 | 1.5 | 1.5 | 1.5 |
| 6PPD | 1 | 1 | 1 | 1 |
| PA | 4 | 3 | 3 | 3 |
| Sunpar 150 | 65 | 65 | 60 | 60 |
| Sulphur | 0.7 | 1 | 1 | 1 |
| MBT | 1.2 | 1.2 | 1.5 | 1.5 |
| DTDM | 0.8 | 1 | 1.2 | 1.2 |
| TMTD | 0.75 | 0.75 | 0.75 | 0.75 |
| TOTAL phr | 329.95 | 389.45 | 364.95 | 344.95 |

After mixing for approximately five minutes to a temperature of 120 degrees C., samples were cured 10 minutes at 177 degrees C. Cured samples were used to determine physical properties as set out in Table 2.

TABLE 2

| PHYSICAL | | | | | |
|---|---|---|---|---|---|
| PROPERTY | | Sample A | Sample B | Sample C | Sample D |
| Rheometer - ODR | | 176 C. | 176 C. | 176 C. | 176 C. |
| ML | TBD | 6.1 | 8.88 | 10.36 | 9.75 |
| Ts2 | TBD | 1.02 | 0.88 | 0.85 | 1.02 |
| Tc50 | TBD | 1.49 | 1.32 | 1.29 | 1.37 |
| Tc90 | TBD | 3.62 | 3.65 | 3.42 | 3.46 |
| MH | TBD | 24.24 | 26.97 | 31.26 | 37.84 |
| Tensile Strength | | | | | |
| Tensile (psi) | 1051 | 1142 | 766 | 1225 | 1561 |
| Elongation | 174 | 540 | 391 | 389 | 353 |
| (%) | | | | | |
| Modulus | | 619 | 659 | 553 | 616 |
| (psi) | | | | | |
| Tear (psi) | 150 | | | | |
| Durometer | 75-85 | 65 | 73 | 80 | 80 |
| Density | | 1.11 | 1.15 | 1.18 | 1.18 |

Samples C and D fulfilled the requirements of the specification. C was chosen for scale up to maximize the bio-filler content in the finished part. A production scale batch was prepared using a Moriyama internal tilt mixer and mixed to 120 degrees C. and milled into slab stock.

The material was cured in a four post compression press to produce finished radiator seals. The preferred curing temperature was determined by varying the cure temperature until a suitable curing cycle was achieved. It was found that curing up to about 177 degrees was preferred. Curing above 177 degrees celcius resulted in substantial fuming of the bio-filler.

The results indicate that synthetic rubber, such as EPDM compounds, that incorporate bio-filler, are suitable for use in making original equipment automotive parts. Equipment conventional to rubber mixing and curing can be used in the production of these automotive parts.

We claim:

1. An elastomeric composite comprising a synthetic rubber which incorporates a biofiller.

2. An elastomeric composite as defined in claim 1, wherein the biofiller comprises up to about 50% by weight of the composite.

3. An elastomeric composite as defined in claim 2, wherein the biofiller comprises up to about 25% by weight of the composite.

4. An elastomeric composite as defined in claim 1, wherein the biofiller is selected from the group consisting of glycerol; canola flour, canola meal, canola oil; soya flour, soya meal, soya oil, soya hull, distiller's dried grain and solutes (DDGS) and any combination thereof.

5. An elastomeric composite as defined in claim 1, wherein the synthetic rubber is selected from the group consisting of polybutadiene; chloro isobutylene isoprene; polychloroprene; chlorosulphonated polyethylene; epichlorohydrin; ethylene propylene; ethylene propylene diene; ethylene vinyl acetate; fluoronated hydrocarbon; hydrogenated nitrile butadiene; polyisoprene; isoprene butylene butyl; butadiene acrylonitrile; polyurethane; styrene butadiene; and poly-siloxane.

6. An elastomeric composite as defined in claim 5, wherein the synthetic rubber is selected from the group consisting of ethylene propylene diene (EPDM), styrene butadiene (SBR), isoprene butylene butyl (IIR), butadiene acrylonitrile (NBR), and polychloroprene (CR).

7. An elastomeric composite as defined in claim 6, wherein the synthetic rubber is ethylene propylene diene (EPDM).

8. An elastomeric composite as defined in claim 1, additionally comprising components selected from the group consisting of an oil, active filler, inactive filler, a curing agent, an accelerator and a retarding agent.

9. An elastomeric composite as defined in claim 1, that exhibits a hardness in the range of about 40-100 Shore A, a tensile strength in the range of about 500-3000 psi and elongation of from about 100-700%.

10. An elastomeric composite as defined in claim 9, that exhibits a hardness in the range of about 75-85 Shore A.

11. A method of making an elastomeric composite comprising the steps of:
i) mixing components comprising a base polymer, a filler and a curing package under conditions suitable to result in a homogenized compound; and
ii) curing the homogenized compound to form the composite.

12. A method as defined in claim 11, wherein said biofiller comprises up to about 50% by weight of the composite.

13. A method as defined in claim 11, wherein the biofiller is selected from the group consisting of glycerol; canola flour, canola meal, canola oil; soya flour, soya meal, soya oil, soya hull, distiller's dried grain and solutes (DDGS) and any combination thereof.

14. A method as defined in claim 11, wherein the synthetic rubber is selected from the group consisting of polybutadiene; chloro isobutylene isoprene; polychloroprene; chlorosulphonated polyethylene; epichlorohydrin; ethylene propylene; ethylene propylene diene; ethylene vinyl acetate; fluoronated hydrocarbon; hydrogenated nitrile butadiene; polyisoprene; isoprene butylene butyl; butadiene acrylonitrile; polyurethane; styrene butadiene; and poly-siloxane.

15. A method as defined in claim 14, wherein the synthetic rubber is selected from the group consisting of ethylene propylene diene (EPDM), styrene butadiene (SBR), isoprene butylene butyl (IIR), butadiene acrylonitrile (NBR), and polychloroprene (CR).

16. A method as defined in claim 11, wherein the components are mixed at a temperature in the range of about 100-180° C.

17. A method as defined in claim 16, wherein the components are mixed at a temperature of about 110-130° C.

18. A method as defined in claim 11, wherein curing step is conducted at a temperature of up to about 180° C.

19. A method as defined in claim 11, wherein curing step is conducted at a temperature of no more than about 177° C.
